(19) United States
(12) Patent Application Publication
(10) Pub. No.: US 2025/0025776 A1
(43) Pub. Date: Jan. 23, 2025

(54) Haptics for Touch-Input Hardware Interfaces of a Game Controller

(71) Applicant: Backbone Labs, Inc., Vancouver, WA (US)

(72) Inventor: Ozhan Maker, San Diego, CA (US)

(73) Assignee: Backbone Labs, Inc., Vancouver, WA (US)

(21) Appl. No.: 18/813,384

(22) Filed: Aug. 23, 2024

Related U.S. Application Data
(63) Continuation of application No. 18/224,508, filed on Jul. 20, 2023, now Pat. No. 12,121,800.
Application No. 18/224,508 is a continuation-in-part of application No. 17/504,299, filed on Oct. 18, 2021.
Application No. 17/504,299 is a continuation-in-part of application No. 16/808,339, filed on Mar. 3, 2020, now Pat. No. 11,389,721.

(51) Int. Cl. A63F 13/285; A63F 13/214; A63F 13/24; A63F 13/92

(52) U.S. Cl. CPC A63F 13/285; A63F 13/214; A63F 13/24; A63F 13/92

(57) ABSTRACT

A handheld game controller having a handle and a bumper assembly on the handle. The bumper assembly includes a bumper and a haptic actuator. The bumper is configured to accept touch inputs from a user. The haptic actuator includes at least one plate and a piezoelectric actuator. The piezoelectric actuator is configured to receive an electrical signal, convert the electrical signal to mechanical motion, translate the mechanical motion to the at least one plate, and cause the at least one plate and the bumper to vibrate.

### CROSS-REFERENCES TO RELATED APPLICATIONS

This patent application is a continuation-in-part of application Ser. No. 17/504,299 filed Oct. 18, 2021, which is a continuation-in-part of application Ser. No. 16/808,339 filed Mar. 3, 2020, now U.S. Pat. No. 11,389,721. Application Ser. Nos. 16/808,339 and 17/504,299 are each incorporated into the present disclosure by this reference.

### TECHNICAL FIELD

The subject matter is related to an apparatus and methods for providing haptic feedback in a handheld game controller.

### BACKGROUND

A game controller is a device used to provide input to a video game, for example to control an object or character in the video game. The video game may be running on a computer, a specially designed gaming system, or a mobile device.

In today's electronic gaming entertainment, haptic engines for game controllers are widely used to increase feelings immersion within the video game. When a user-controlled video-game character opens a virtual door in game, this action can be assigned through hooks in the game software to actuate haptic feedback within the gaming device. The tactile sensation in the game player's fingertip is interpreted by the game player's brain to associate it with, in this example, the heft of the door opening. This helps to promote immersion of the game player into the game.

Conventional haptic engines for game controllers are generally of two types: eccentric rotating mass (ERM) and linear resonant actuator (LRA). The ERM-type of haptic engine includes a mass attached to a motor shaft, where the mass is not evenly distributed around the shaft. Thus, when the motor shaft rotates the mass, it causes the device to which the ERM haptic engine is attached to shake. The LRA-type of haptic engine creates vibration by moving a mass in a reciprocal manner by means of a voice-coil drive pushing the mass against a spring. The spring tends to resist the motion of the mass and push the mass back toward its starting point.

Configurations of the disclosed technology address shortcomings in the prior art.

### BRIEF DESCRIPTION OF THE DRAWINGS

FIG. 1 is a perspective view of a handheld game controller, according to an example configuration, and illustrating an example mobile device that is secured within the handheld game controller.

FIG. 2 is a top perspective view of the game controller of FIG. 1.

FIG. 3 is a front view of the handheld game controller of FIG. 1.

FIG. 4 is a top view of the handheld game controller of FIG. 1, shown in an example extended position.

FIG. 5 is a top view of the handheld game controller of FIG. 1, shown in an example retracted position.

FIG. 6 is a partial sectional view of a portion of FIG. 1, illustrating an example haptic actuator embedded in the touch-input hardware interface.

FIG. 7 is a partial sectional view of a portion of FIG. 1, illustrating an example haptic actuator in direct, physical contact with the touch-input hardware interface.

### DETAILED DESCRIPTION

As described herein, aspects are directed to an apparatus and method for providing haptic feedback in a handheld game controller. In configurations, a handheld game controller includes a haptic actuator as part of the assembly for a touch-input hardware interface. The touch-input hardware interface may be, for example, a bumper or trigger, and other examples are noted below. The haptic actuator includes a piezoelectric actuator that provides haptic feedback to the user through the touch-input hardware interface (e.g., the bumper or trigger). Additionally, configurations include capacitive touch sensor to engage and disengage the piezoelectric actuator in response to the user's touch. Also, in configurations having more than one piezoelectric actuator on a given touch-input hardware interface (e.g., a bumper or trigger), the separate piezoelectric actuators may be engaged simultaneously or at separate times (and perhaps in a certain sequence) to provide different types of haptic feedback to the user's finger. In addition to the benefits just noted, configurations of the disclosed technology help to differentiate haptics coming from a haptic engine in the mobile device from the haptics generated from within the game controller. This is accomplished by, for example, focusing the haptic feedback on a particular part of the game controller, such as a particular bumper or trigger.

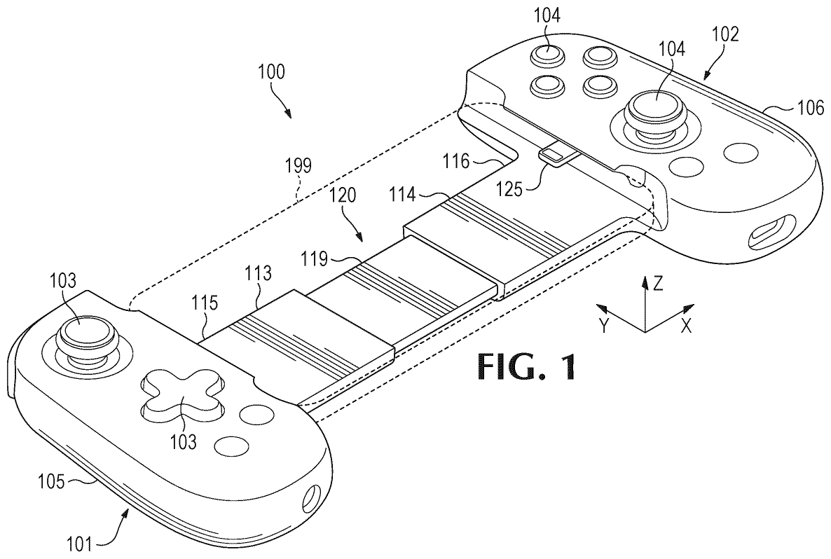

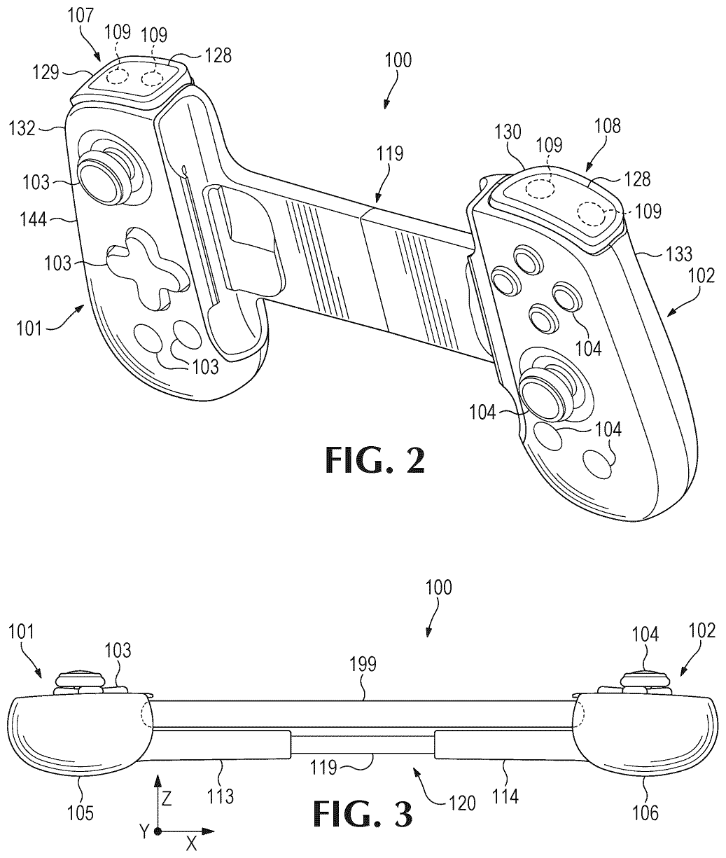

FIG. 1 is a perspective view showing portions of a handheld game controller, according to an example configuration. FIG. 2 is a top perspective view of the game controller of FIG. 1.

As illustrated in FIGS. 1 and 2, a game controller 100 may include a first handle 101, a second handle 102, and a bridge 119. Each of the first handle 101 and the second handle 102 is configured to contact and support a mobile device 199, though not all contemplated embodiments will include the second handle 102. An exemplary mobile device 199 is shown in broken lines to illustrate how the game controller 100 may contact and support a mobile device 199 in some embodiments. The mobile device 199 may be, as examples, a smartphone or a tablet computer.

As illustrated in FIGS. 1 and 2, the first handle 101 includes a guide portion 113 and a main body portion 105. The guide portion 113 extends from the main body portion 105 and along a first end 115 of the span 120 of the bridge 119. The guide portion 113 of the first handle 101 is configured to align the bridge 119 with the main body portion 105 of the first handle 101.

As illustrated, the first handle 101 includes a user-accessible, first hardware interface 103 on the main body portion 105 of the first handle 101. The first hardware interface 103 could be a button, a bumper, a trigger, an analog stick, a touchscreen, a touchpad, a knob, a slider, a switch, a wheel, a dial, a directional pad, or another such feature configured to accept touch inputs from a user's finger or a stylus. As shown in FIGS. 1 and 2, the first hardware interface 103 may include multiple such hardware interfaces.

As best illustrated in FIG. 2, the user-accessible, first hardware interface 103 may include a first touch-input hardware interface 129 coupled to the first handle 101. The first touch-input hardware interface 129 is configured to accept touch inputs from a user. For example, the user might depress the first touch-input hardware interface 129 with the user's index finger or middle finger. As illustrated, the first touch-input hardware interface 129 may be at a top edge 131 of the main body portion 105 of the first handle 101. The main body portion 105 is confined by a housing 132 of the first handle 101. As illustrated in the drawings, in configurations the first touch-input hardware interface 129 projects from the housing 132 of the first handle 101. The first touch-input hardware interface 129 may be, for example, a bumper or trigger, or it may be one of the other features noted above for the first hardware interface 103 that are configured to accept touch inputs from a user's finger or a stylus. Typically, though, the first touch-input hardware interface 129 is a mechanical input device, such as a button, a bumper, a trigger, an analog stick, a knob, a slider, a switch, a wheel, a dial, or a directional pad.

Referring to FIGS. 1 and 2 together, the second handle 102 likewise includes a guide portion 114 and a main body portion 106. The guide portion 114 extends from the main body portion 106 and along a second end 116 of the span 120 of the bridge 119. The guide portion 114 of the second handle 102 is configured to align the bridge 119 with the main body portion 106 of the second handle 102.

As illustrated, the second handle 102 further includes a user-accessible, second hardware interface 104 on the main body portion 106 of the second handle 102. As above for the first hardware interface 103 of the first handle 101, the second hardware interface 104 could be a button, a bumper, a trigger, an analog stick, a touchscreen, a touchpad, a knob, a slider, a switch, a wheel, a dial, a directional pad, or another such feature configured to accept touch inputs from a user's finger or a stylus. The second hardware interface 104 may include multiple such hardware interfaces, as illustrated in FIGS. 1 and 2.

As best illustrated in FIG. 2, the user-accessible, second hardware interface 104 may include a second touch-input hardware interface 154 coupled to the second handle 102. The second touch-input hardware interface 154 is configured to accept touch inputs from a user as described above for the first touch-input hardware interface 129. As illustrated, the second touch-input hardware interface 154 may be at a top edge of the main body portion 106 of the second handle 102. The main body portion 106 is confined by a housing 133 of the second handle 102. As illustrated in the drawings, in configurations the second touch-input hardware interface 154 projects from the housing 133 of the second handle 102. The second touch-input hardware interface 154 may be, for example, a bumper or trigger, or it may be one of the other features noted above for the second hardware interface 104 that are configured to accept touch inputs from a user's finger or a stylus. Typically, though, the second touch-input hardware interface 154 is a mechanical input device, such as a button, a bumper, a trigger, an analog stick, a knob, a slider, a switch, a wheel, a dial, or a directional pad.

One or both of the first handle 101 and the second handle 102 may include a connector 125 for physical and electrical connection to the mobile device 199. The connector 125 may be, for example, a USB-C connector.

It is noted that each of FIGS. 1, 3, 4, and 5 includes indications showing the directions of mutually orthogonal x-, y-, and z-axes. These are used to orient the reader and to assist with the descriptions of the illustrated configurations. Accordingly, the bridge 119 lies in the x-y plane as illustrated, and the intended gameplay position of the mobile device 199 is substantially parallel to the x-y plane of the bridge 119, such as is illustrated in FIGS. 1 and 3-5. As used in this context, “substantially parallel” means largely or essentially equidistant from the x-y plane at all points, without requiring perfect parallelism.

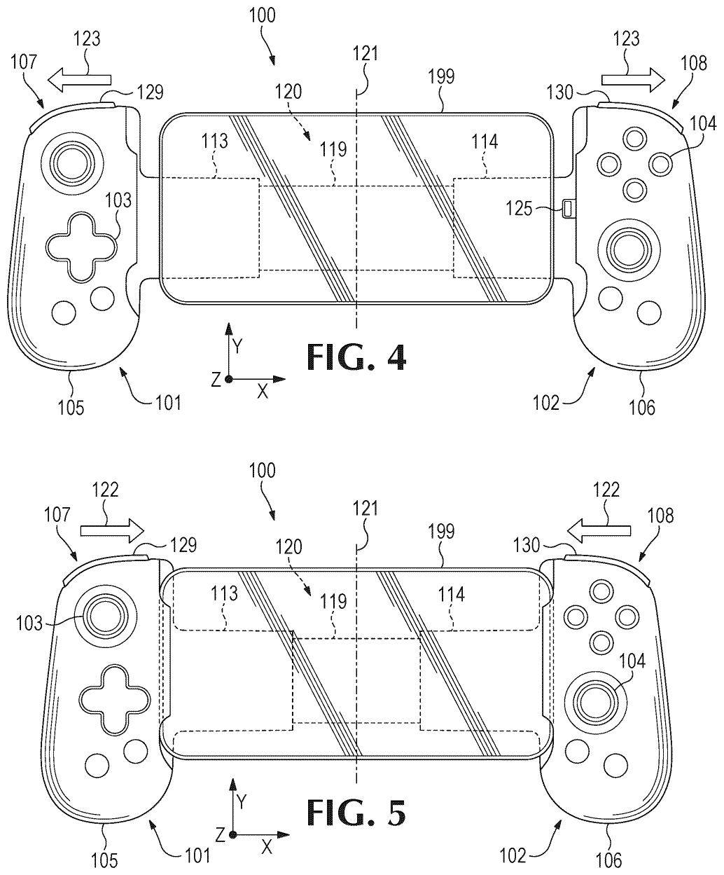

FIG. 3 is a front view of the handheld game controller of FIG. 1. FIG. 4 is a top view of the handheld game controller of FIG. 1, shown in an example extended position. And FIG. 5 is a top view of the handheld game controller of FIG. 1, shown in an example retracted position. FIGS. 3-5 illustrate an example of how a mobile device 199 may be installed into the game controller 100. As illustrated in FIG. 4, the mobile device 199 may be placed over the bridge 119, between the first handle 101 and the second handle 102 of the game controller 100. The connector 125 of the game controller 100 may be joined with a corresponding connector on the mobile device 199. FIG. 4 shows an example of an extended configuration of the game controller 100, where the handles are extended away from each other a sufficient distance to allow the mobile device 199 to be inserted. In FIG. 5, the mobile device 199 is secured between the first handle 101 and the second handle 102 of the game controller 100. FIGS. 3 and 5 illustrate an example of a retracted configuration of the game controller 100, where the handles are retracted toward each other such that the mobile device 199 contacts the contact zone (explained below). The extended configuration and the retracted configuration of the game controller 100 are described in more detail below.

Hence, as illustrated the bridge 119 is in sliding engagement with the first handle 101. In the illustrated configuration, the bridge 119 is not telescoping, meaning that segments of the bridge 119 do not slide within another segment of the bridge 119 to allow for lengthening or shortening of the bridge 119. The bridge 119 has a span 120 extending away from the main body portion 105 of the first handle 101, and the span 120 has a transverse midline 121.

The bridge 119 and the first handle 101 are configured to allow the main body portion 105 of the first handle 101 to translate in a retraction direction 122 toward the midline 121 of the bridge 119 and into a retracted configuration, an example of which is illustrated in FIGS. 3 and 5. The bridge 119 and the first handle 101 are configured to allow the main body portion 105 of the first handle 101 to also translate in an extension direction 123 away from the midline 121 of the bridge 119 into an extended configuration, an example of which is illustrated in FIG. 4.

As used in this disclosure, the transverse midline 121 of the bridge 119 is a reference datum used to define the extension direction 123 and the retraction direction 122. That is, the retraction direction 122 is toward the transverse midline 121, while the retraction direction 122 is away from the transverse midline 121. Accordingly, the transverse midline 121 of the bridge 119 may or may not coincide with a physical structure on the game controller 100.

Likewise, the bridge 119, as illustrated, is in sliding engagement with the second handle 102, and the span 120 of the bridge 119 extends away from the main body portion 106 of the second handle 102. The bridge 119 and the second handle 102 are configured to allow the main body portion 106 of the second handle 102 to translate in the retraction direction 122 toward the midline 121 of the bridge 119 and into the retracted configuration. The bridge 119 and the second handle 102 are configured to allow the main body portion 106 of the second handle 102 to also translate in the extension direction 123 away from the midline 121 of the bridge 119 into the extended configuration.

In configurations, the bridge 119 is configured such that the first handle 101 and the second handle 102 are equidistant from the midline 121 of the bridge 119 in the retracted configuration and in the extended configuration. In configurations, the bridge 119 is configured such that the first handle 101 and the second handle 102 are equidistant from the midline 121 of the bridge 119 when the first handle 101 and the second handle 102 are translating from the retracted configuration to the extended configuration. In configurations, the bridge 119 is configured such that the first handle 101 and the second handle 102 are equidistant from the midline 121 of the bridge 119 when the first handle 101 and the second handle 102 are translating from the extended configuration to the retracted configuration.

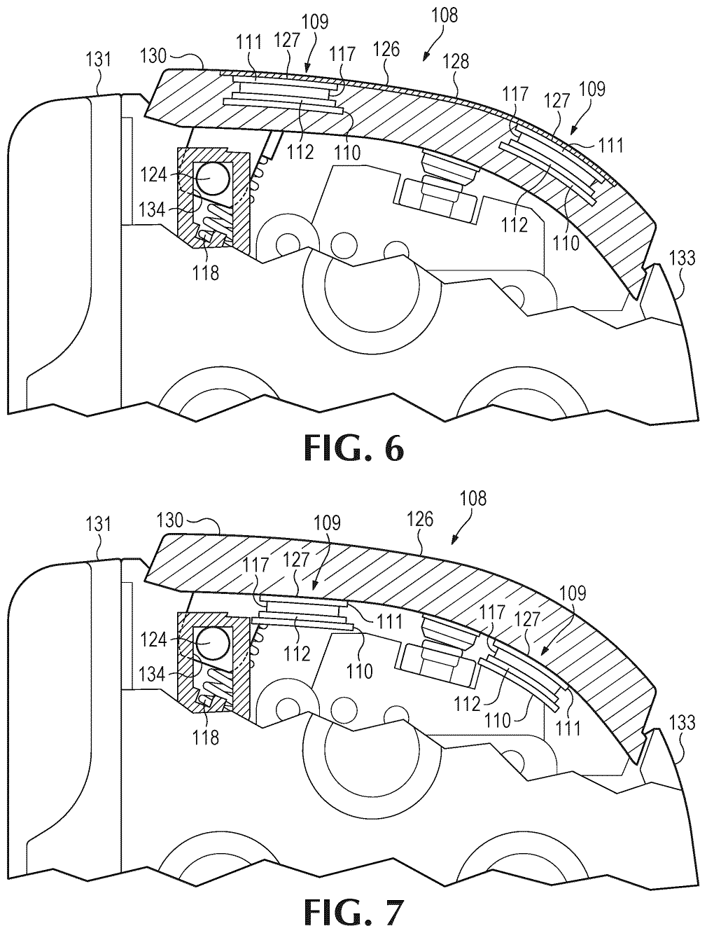

FIG. 6 is a partial sectional view of a portion of the second handle 102 of FIG. 1, illustrating an example haptic actuator 109 embedded in the second touch-input hardware interface 130. FIG. 7 is a partial sectional view of a portion of the second handle 102 of FIG. 1, illustrating an example haptic actuator 109 in direct, physical contact with the second touch-input hardware interface 130. While illustrated and described for the second handle 102, the discussion of FIGS. 6 and 7 applies also to the first handle 101. Indeed, the game controller 100 may include a touch-input assembly on one or both handles, namely the first touch-input assembly 107, which includes the first touch-input hardware interface 129, and the second touch-input assembly 108, which includes the second touch-input hardware interface 130.

As illustrated in FIGS. 6 and 7, the second touch-input assembly 108 includes a second touch-input hardware interface 130 and a haptic actuator 109.

The touch-input hardware interface is configured to accept touch inputs from a user. In configurations, the touch-input hardware interface may be, for example, a button, a bumper, a trigger, an analog stick, a knob, a slider, a switch, a wheel, a dial, or a directional pad. In the illustrated configuration, the touch-input hardware interface is a bumper or trigger that the user might depress, typically with the user's index finger or middle finger.

As illustrated, the haptic actuator 109 includes a first plate 111, a second plate 112, and a piezoelectric actuator 117. While the illustrated configuration shows two plates, the first plate 111 and the second plate 112, some configurations have just one plate and some configurations have more than two plates. As illustrated, the first plate 111, the second plate 112, and the piezoelectric actuator 117 are in layers, with the piezoelectric actuator 117 being between the first plate 111 and the second plate 112.

The piezoelectric actuator 117, or piezoelectric transducer, is configured to receive an electrical signal, convert the electrical signal to mechanical motion, translate the mechanical motion to the first plate 111 and the second plate 112, and cause the first plate 111 and the second plate 112 to vibrate. The electrical signal to the piezoelectric actuator 117 may come from, as examples, a processor within the game controller 100 or a processor within the mobile device 199. The processor within the game controller 100 may be, for example, part of a printed circuit board within the second handle 102. Vibration of the plates, in turn, causes the second touch-input hardware interface 130 to vibrate. Accordingly, the haptic actuator 109 causes haptic vibration without the use of an eccentric rotating mass (ERM) or a linear resonant actuator (LRA). ERM- and LRA-type haptic actuators 109 are too bulky for the application described here and would not allow the second touch-input assembly 108 (which includes the haptic actuator 109) to translate as a unit relative to the second handle or to focus the haptic feedback sensation (i.e. the vibrations) to a specific portion of the game controller 100, such as to the second touch-input assembly 108. In addition, ERM- and LRA-type haptic actuators 109 require more electrical power than the technologies discussed in this disclosure. Thus, the described technologies require less battery power, resulting in longer battery life, less frequent recharging of the battery, and less need to be tethered by a cord to an electrical outlet to provide power to depleted batteries.

In some example configurations, the layers of the haptic actuator 109 include a capacitive touch sensor 128, such as a capacitive touch film. The capacitive touch sensor 128 is configured to detect presence of a finger of the user on the second touch-input hardware interface 130. Such capacitive touch sensors 128 typically have a grid of electrodes that complete an electrical circuit in response to a user's touch. Accordingly, in configurations the haptic actuator 109 is “off” unless the capacitive touch sensor 128 detects a user's finger on the second touch-input hardware interface 130. If a user's finger is detected, then the haptic actuator 109 is “on” and will cause the plate(s) to vibrate in response to an electrical signal as described above. In such configurations, battery power may be conserved by not activating the haptic feedback when the user's finger is not in place on the corresponding touch-input hardware interface. As illustrated in FIG. 6, the capacitive touch sensor 128 may be affixed to the outward surface of the second touch-input hardware interface 130. The outward surface is the surface indicated as including the contact surface area 126 and coincides with the input surface (which is described below) of the second touch-input hardware interface 130. In some example configurations, the layers of the haptic actuator 109 do not include a capacitive touch sensor 128.

In configurations, the layers of the haptic actuator 109 include a flexible, printed circuit board 110. In configurations, the flexible circuit board 110 is connected via a flexible cable to the main circuit board of the game controller 100. As noted above, that main printed circuit board may be within the second handle 102, or it may be elsewhere within the game controller 100.

As illustrated in FIGS. 6 and 7, the second touch-input hardware interface 130 and the haptic actuator 109 translate as a unit relative to the handle. To accomplish that, the second touch-input assembly 108 is not rigidly coupled to the housing 133 of the second handle 102. Rather, the second touch-input assembly 108 is connected to the housing 133 through a non-rigid connection, such as through a pivot rod 124 and a spring 118 as illustrated in FIGS. 6 and 7. As used in this context, a rigid coupling would not allow the coupled components to be moved relative to each other without causing permanent damage to either component. Accordingly, in such configurations the second touch-input assembly 108 is isolated from the main body portion 106 of the second handle 106 (because of the lack of a rigid coupling between them) and, likewise, from the remainder of the game controller 100.

As illustrated, a track slot 134 is rigidly coupled to the housing 133, and the second touch-input hardware interface 130 includes a pivot rod 124. The pivot rod 124 is configured to engage the track slot 134 of the second handle 102. The pivot rod 124 is configured to rotate within the track slot 134 and to translate within the track slot 134. Accordingly, the pivot rod 124 and track slot 134 provide a dual-action coupling between the second touch-input assembly 108 and the housing 133 of the second handle 102, the two actions being rotation and translation. The spring 118 is configured to bias the second touch-input hardware interface 130 into the upward, or undepressed, position, an example of which is shown in FIGS. 6 and 7. Hence, in configurations where the haptic actuator 109 translates as a unit relative to the handle and the touch-input assembly is connected to the housing 133 through a non-rigid connection, the haptic feedback provided by the haptic actuator 109 may be focused on a particular part of the game controller (namely the second touch-input hardware interface 130 to which the particular haptic actuator 109 is coupled) rather than the game controller as a whole.

As noted above, FIG. 6 illustrates a haptic actuator 109 that is embedded in the second touch-input hardware interface 130. As used in this context, “embedded” means that the haptic actuator 109 is snugly enclosed in the second touch-input hardware interface 130, which substantially surrounds the haptic actuator 109. As used in this context, “substantially surrounds” means largely or essentially extending around, without requiring perfect encircling. By contrast, FIG. 7 illustrates a haptic actuator 109 that, instead of being embedded in the second touch-input hardware interface 130, is in direct, physical contact with the second touch-input hardware interface 130. In the example configuration of FIG. 7, then, the haptic actuator 109 is coupled to an underside of the second touch-input hardware interface 130. In other configurations, the haptic actuator 109 could be coupled to another part of the second touch-input assembly 108. These two configurations (i.e. embedded within the second touch-input hardware interface 130 or being in direct, physical contact with the second touch-input hardware interface 130) each provide non-dampened, no-gap contact between the haptic actuator 109 and the second touch-input hardware interface 130, which transfers the mechanical force (i.e. the vibration) of the haptic actuator 109 to the input surface (i.e. where the user places their finger during typical use) of the second touch-input hardware interface 130.

As best illustrated in FIGS. 2, 6, and 7, the second touch-input hardware interface 130 has a contact surface area 126 of an outward surface of the second touch-input hardware interface 130. The outward surface of the second touch-input hardware interface 130 is configured to receive touch inputs from the user and coincides with the input surface of the second touch-input hardware interface 130. The haptic actuator 109 has a planform area 127 in the y-axis. For the illustrated configuration, this planform area 127 is indicated by the dashed-line circles 109 in FIG. 2. (The planform area 127 is shown from the side in FIGS. 6 and 7.) In configurations, the planform area 127 of the haptic actuator 109 is less than the contact surface area 126 of the outward surface of the second touch-input hardware interface 130.

In configurations, a single touch-input hardware interface may include more than one haptic actuator 109. The haptic actuators 109 may be spaced apart to provide haptic feedback (i.e. vibrations) to different parts of the input surface. While FIG. 2 shows an example of the touch-input hardware interfaces each having two haptic actuators 109, other configurations could have more than two haptic actuators 109. For example a single touch-input hardware interface may include four haptic actuators 109 arranged at the corners of a rectangular shape. In configurations having more than one haptic actuator 109 on a single touch-input hardware interface, the haptic actuators 109 can be activated and deactivated individually. Accordingly, the haptic actuators 109 can be turned “on” and “off” separately (including in a particular sequence). Thus, while conventional systems either have the haptics on or off, configurations of the disclosed technology provide a range of haptic feedback by engaging one haptic actuator 109 on a touch-input hardware interface (e.g. a bumper or trigger), multiple haptic actuators 109 on the same touch-input hardware interface simultaneously, or multiple haptic actuators 109 on the same touch-input hardware interface individually (including sequentially). Engaging the haptic actuators 109 sequentially may provide, for example, a sense of movement to the user. Additionally, engaging more than one of the haptic actuators 109 at the same time may provide, for example, a sense of stronger force to the user as compared to when fewer haptic actuators 109 are engaged.

Although described with respect to the illustrated bumper, it is recognized that the disclosed haptics technology could be applied to other types of user-accessible, touch-input hardware interfaces such as, for example, a button, an analog stick, a touchscreen, a touchpad, a knob, a slider, a switch, a wheel, a dial, a directional pad, and a trigger.

In use, the user holds the game controller in the customary way. That typically means holding each handle with the user's thumbs available to activate the hardware interfaces 103, 104 (e.g., buttons, joysticks, etc.) on the front side of the handles 101, 102. The user's index or middle finger is typically available to activate the touch-input hardware interfaces 129, 130 (e.g. the bumpers, triggers, etc.) at the top edge 131 of the handle 101, 102. With the user's finger(s) resting on the touch-input hardware interface(s), in configurations having the capacitive touch sensor 128, the capacitive touch sensor 128 would detect the presence of the user's finger and send a signal, either directly to the corresponding haptic actuator 109 or to another processor, to turn the haptic actuator 109 “on” so that it will vibrate in response to a received electrical signal indicative of when haptic feedback should occur during gameplay. As noted, each touch-input hardware interface may have more than one haptic actuator 109. In such configurations, the haptic actuators 109 can be controlled separately to provide haptic feedback to the user that is more complex and immersive than (a) the haptics provided by the mobile device itself, (b) a single haptic engine rigidly coupled to the housing of the game controller, or (c) a single haptic actuator 109 for the particular touch-input hardware interface.

### Examples

Illustrative examples of the disclosed technologies are provided below. A particular configuration of the technologies may include one or more, and any combination of, the examples described below.

Example 1 includes a handheld game controller comprising: a handle; and a bumper assembly on the handle, the bumper assembly comprising: a bumper configured to accept touch inputs from a user, and a haptic actuator comprising at least one plate and a piezoelectric actuator configured to receive an electrical signal, convert the electrical signal to mechanical motion, translate the mechanical motion to the at least one plate, and cause the at least one plate and the bumper to vibrate.

Example 2 includes the handheld game controller of Example 1, in which the bumper assembly is configured to translate as a unit relative to the handle.

Example 3 includes the handheld game controller of any of Examples 1-2, in which the handle further comprises a housing from which the bumper projects, and in which the bumper assembly is not rigidly coupled to the housing.

Example 4 includes the handheld game controller of Example 3, in which the bumper assembly is connected to the housing through at least one spring and at least one pivot.

Example 5 includes the handheld game controller of any of Examples 1-4, in which the bumper has a contact surface area of an outward surface of the bumper, the outward surface of the bumper being configured to receive touch inputs from the user, the haptic actuator having a planform area, the planform area of the haptic actuator being less than the contact surface area of the outward surface of the bumper.

Example 6 includes the handheld game controller of any of Examples 1-5, in which the haptic actuator further includes a capacitive touch sensor configured to detect presence of a finger of the user on the bumper.

Example 7 includes the handheld game controller of any of Examples 1-6, in which the haptic actuator does not include an eccentric rotating mass or a linear resonant actuator to cause vibration.

Example 8 includes the handheld game controller of any of Examples 1-7, in which the haptic actuator comprises layers, the layers including a first plate; a second plate; and the piezoelectric actuator; the piezoelectric actuator being between the first plate and the second plate, the piezoelectric actuator configured to receive the electrical signal and mechanically vibrate the first plate and the second plate in response to the electrical signal.

Example 9 includes the handheld game controller of Example 8, the layers of the haptic actuator further including a capacitive touch sensor configured to detect presence of a finger of the user on the bumper.

Example 10 includes the handheld game controller of any of Examples 1-9, in which the haptic actuator is in direct, physical contact with the bumper.

Example 11 includes the handheld game controller of any of Examples 1-10, in which the haptic actuator is embedded in the bumper.

Example 12 includes the handheld game controller of any of Examples 1-11, in which the handle is a first handle, the handheld game controller further comprising: a second handle; a bridge connecting the first handle and the second handle; a second bumper assembly on the second handle, the second bumper assembly comprising: a second bumper configured to accept touch inputs from the user, and a second haptic actuator comprising at least one plate and a piezoelectric actuator configured to receive an electrical signal, convert the electrical signal to mechanical motion, translate the mechanical motion to the at least one plate of the second haptic actuator, and cause the at least one plate of the second haptic actuator and the second bumper to vibrate.

Example 13 includes the handheld game controller of Example 12, in which the bridge is in sliding engagement with the first handle and the second handle, the bridge having a span extending away from the first handle, the span having a transverse midline, the midline of the bridge being between the first handle and the second handle, the bridge and the first handle being configured for the first handle to translate in a retraction direction toward the midline of the bridge and into a retracted configuration and also to translate in an extension direction away from the midline of the bridge into an extended configuration, the bridge and the second handle being configured for the second handle to translate along the bridge in the retraction direction toward the midline of the bridge and into the retracted configuration and also to translate in the extension direction away from the midline of the bridge and into the extended configuration.

Example 14 includes the handheld game controller of any of Examples 1-13, further comprising a mobile device contacted and supported by the first handle and the second handle.

Example 15 includes the handheld game controller of any of Examples 1-14, in which the haptic actuator is a plurality of haptic actuators, each haptic actuator of the plurality of haptic actuators comprising at least one plate and a piezoelectric actuator configured to receive an electrical signal, convert the electrical signal to mechanical motion, translate the mechanical motion to the at least one plate, and cause the at least one plate and the bumper to vibrate, each haptic actuator of the plurality of haptic actuators being separably controllable to turn off and on independently of another haptic actuator of the plurality of haptic actuators.

Example 16 includes a handheld game controller comprising: a handle; and a touch-input assembly on the handle, the touch-input assembly comprising: a touch-input hardware interface configured to accept touch inputs from a user, and a haptic actuator comprising at least one plate and a piezoelectric actuator configured to receive an electrical signal, convert the electrical signal to mechanical motion, translate the mechanical motion to the at least one plate, and cause the at least one plate to vibrate.

Example 17 includes the handheld game controller of Example 16, in which the touch-input assembly is configured to translate as a unit relative to the handle.

Example 18 includes the handheld game controller of any of Examples 16-17, in which the handle further comprises a housing from which the touch-input hardware interface projects, and in which the touch-input assembly is not rigidly coupled to the housing.

Example 19 includes the handheld game controller of any of Examples 16-18, in which the haptic actuator does not include an eccentric rotating mass or a linear resonant actuator to cause vibration.

Example 20 includes the handheld game controller of any of Examples 16-19, in which the haptic actuator comprises layers, the layers including: a first plate; a second plate; and a piezoelectric transducer between the first plate and the second plate, the piezoelectric transducer configured to receive an electrical signal and mechanically vibrate the first plate and the second plate in response to the electrical signal.

Example 21 includes the handheld game controller of Example 20, the layers of the haptic actuator further including a capacitive touch sensor configured to detect presence of a finger of the user on the touch-input hardware interface.

Example 22 includes the handheld game controller of any of Examples 16-21, in which the touch-input hardware interface is selected from the group consisting of a button, an analog stick, a knob, a slider, a switch, a wheel, a dial, a directional pad, and a trigger.

Aspects may operate on a particularly created hardware, on firmware, digital signal processors, or on a specially programmed general purpose computer including a processor operating according to programmed instructions. The terms “controller” or “processor” as used herein are intended to include microprocessors, microcomputers, ASICs, and dedicated hardware controllers. One or more aspects may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, RAM, etc. As will be appreciated by one of skill in the art, the functionality of the program modules may be combined or distributed as desired in various configurations. In addition, the functionality may be embodied in whole or in part in firmware or hardware equivalents such as integrated circuits, field programmable gate arrays (FPGA), and the like. Particular data structures may be used to more effectively implement one or more aspects of the disclosed systems and methods, and such data structures are contemplated within the scope of computer executable instructions and computer-usable data described herein.

The previously described versions of the disclosed subject matter have many advantages that were either described or would be apparent to a person of ordinary skill. Even so, all of these advantages or features are not required in all versions of the disclosed apparatus, systems, or methods.

Additionally, this written description makes reference to particular features. It is to be understood that the disclosure in this specification includes all possible combinations of those particular features. For example, where a particular feature is disclosed in the context of a particular example configuration, that feature can also be used, to the extent possible, in the context of other example configurations.

Also, when reference is made in this application to a method having two or more defined steps or operations, the defined steps or operations can be carried out in any order or simultaneously, unless the context excludes those possibilities.

Furthermore, the term “comprises” and its grammatical equivalents are used in this application to mean that other components, features, steps, processes, operations, etc. are optionally present. For example, an article “comprising” or “which comprises” components A, B, and C can contain only components A, B, and C, or it can contain components A, B, and C along with one or more other components.

Also, directions such as “vertical,” “horizontal,” “right,” and “left” are used for convenience and in reference to the views provided in figures. But the game controller may have a number of orientations in actual use. Thus, a feature that is vertical, horizontal, to the right, or to the left in the figures may not have that same orientation or direction in actual use.

Although specific example configurations have been described for purposes of illustration, it will be understood that various modifications may be made without departing from the spirit and scope of the disclosure.

1-22. (canceled)

23. A handheld game controller for a mobile device, the handheld game controller comprising:
a first handle;
a second handle movable with respect to the first handle, wherein the first and second handles are configured to support a mobile device positioned between the first and second handles; and
a haptic actuator configured to vibrate in response to receiving a signal from a processor in the mobile device.

24. The handheld game controller of claim 23, wherein the mobile device comprises its own haptic actuator.

25. The handheld game controller of claim 24, wherein haptic feedback provided by the haptic actuator in the handheld game controller is more complex and immersive than haptic feedback provided by the haptic actuator in the mobile device.

26. The handheld game controller of claim 24, wherein the haptic actuator in the handheld game controller is configured to vibrate a portion of the handheld game controller to differentiate haptics generated by the haptic actuator in the handheld game controller from haptics generated by the haptic actuator in the mobile device.

27. The handheld game controller of claim 23, further comprising a connector on an inside edge of one of the first and second handles, the connector being configured to connect with a corresponding connector on an edge of the mobile device, wherein the signal from the processor in the mobile device is received via the connector.

28. The handheld game controller of claim 27, wherein the connector comprises a USB-C connector.

29. The handheld game controller of claim 27, wherein:
the haptic actuator is located in the first handle;
the connector is connected with a circuit board in the second handle; and
the handheld game controller further comprises a cable running between the first and second handles, the cable connecting the haptic actuator in the first handle with the circuit board in the second handle.

30. The handheld game controller of claim 29, wherein the cable comprises a flexible cable.

31. The handheld game controller of claim 23, wherein at least one of the first and second handles comprises a bottom support portion configured to support a bottom of the mobile device and a top support portion configured to support a top of the mobile device.

32. The handheld game controller of claim 31, wherein a length of the bottom support portion is longer than a length of the top support portion.

33. The handheld game controller of claim 23, further comprising a user input device, wherein the haptic actuator is configured to vibrate the user input device in response to receiving a signal from a processor in the mobile device.

34. The handheld game controller of claim 33, wherein the user input device comprises a button, a bumper, a trigger, an analog stick, a knob, a slider, a switch, a wheel, a dial, or a directional pad.

35. The handheld game controller of claim 23, wherein the haptic actuator does not include an eccentric rotating mass or a linear resonant actuator.

36. The handheld game controller of claim 23, wherein the haptic actuator comprises at least one plate and a piezoelectric actuator configured to convert the signal from the processor in the mobile device to mechanical motion, translate the mechanical motion to the at least one plate, and cause the at least one plate to vibrate.

37. The handheld game controller of claim 23, wherein:
the haptic actuator comprises a first plate, a second plate, and a piezoelectric actuator,
the piezoelectric actuator is positioned between the first plate and the second plate; and
the piezoelectric actuator is configured to vibrate the first plate and the second plate in response to the signal from the processor in the mobile device.

38. A handheld game controller for a mobile device, the handheld game controller comprising:
a first handle;
a second handle;
a bridge comprising a transverse midline positioned between the first and second handles, wherein:
the first and second handles are slidable along the bridge between extended and retracted positions;
the first and second handles move away from the transverse midline in moving from the retracted position to the extended position;
the first and second handles move toward the transverse midline in moving from the extended position to the retracted position;
a mobile device is receivable between the first and second handles when the first and second handles are in the extended position; and
the mobile device is supported by the first and second handles when the first and second handles are in the retracted position;
a connector on an inside edge of one of the first and second handles, wherein the connector is configured to connect with a corresponding connector on an edge of the mobile device; and
a haptic actuator configured to vibrate in response to receiving a signal from a processor in the mobile device via the connector.

39. The handheld game controller of claim 38, wherein the mobile device comprises its own haptic actuator.

40. The handheld game controller of claim 38, wherein the haptic actuator does not include an eccentric rotating mass or a linear resonant actuator.

41. The handheld game controller of claim 38, wherein:
the haptic actuator is located in the first handle;
the connector is located on the second handle; and
the handheld game controller further comprises a cable running though the bridge, the cable providing a signal path for the signal from the second handle to the first handle.

42. The handheld game controller of claim 41, wherein the cable comprises a flexible cable.

43. A method comprising:
performing in a handheld game controller comprising first and second handles that support a mobile device between the first and second handles:
receiving a signal from a processor in the mobile device indicative of haptic feedback to be provided during gameplay of a video game running on the mobile device; and
causing a portion of the handheld game controller to vibrate in response to the signal received from the processor in the mobile device.

44. The method of claim 43, wherein the handheld game controller and the mobile device each comprises a respective haptic actuator, and wherein the haptic feedback is provided during gameplay by the haptic actuator in the handheld game controller.

45. The method of claim 44, wherein the haptic actuator in the handheld game controller does not include an eccentric rotating mass or a linear resonant actuator.

46. The method of claim 43, wherein the handheld game controller comprises a connector on one of the first and second handles that mates with a corresponding connector on the mobile device, wherein the signal from the processor in the mobile device is received via the connector.

47. The method of claim 43, further comprising:
sending the signal between the first and second handles via a cable.

48. The method of claim 47, wherein the cable comprises a flexible cable.
